(19) United States
(12) Patent Application Publication
(10) Pub. No.: US 2010/0262506 A1
(43) Pub. Date: Oct. 14, 2010

(54) MOBILE CONTENT DELIVERY ON A MOBILE NETWORK

(75) Inventors: Kamran R. Zargahi, Seattle, WA (US); Michael Christopher Connolly, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/420,700

(22) Filed: Apr. 8, 2009

(51) Int. Cl. G06Q 30/00; H04M 3/42

(52) U.S. Cl. 705/26; 705/34; 455/414.1

(57) ABSTRACT

Embodiments related to mobile content delivery are disclosed. One disclosed embodiment provides a method of facilitating mobile content delivery on a mobile network. The method comprises receiving a purchase request from a network client at a mobile marketplace system; prompting the network client to provide a billing preference; receiving the billing preference from the network client at the mobile marketplace system, the billing preference indicating a billing party; authenticating a billing relationship between the network client and a mobile operator if the billing preference indicates the mobile operator as the billing party; authenticating a billing relationship between the network client and the mobile marketplace system if the billing preference indicates the mobile marketplace system as the billing party; and providing a mobile content item from the mobile marketplace system to the network client if the billing relationship between the network client and the billing party is authenticated.

### BACKGROUND

Electronic communication networks enable customers to purchase media content via a network computing device. Financial transactions may be conducted electronically to facilitate the purchase of media content over electronic communication networks. Electronic financial transactions may utilize electronic authentication of the customer in order to provide for a secure transaction between the customer and the media content provider and to verify the identity of the customer.

### SUMMARY

Accordingly, various embodiments related to mobile content delivery are disclosed herein. For example, one disclosed embodiment provides a method of facilitating mobile content delivery on a mobile network. The method comprises receiving a purchase request from a network client at a mobile marketplace system, where the purchase request indicates a mobile content item to be purchased by the network client, and prompting the network client to provide a billing preference. The method further comprises receiving the billing preference from the network client at the mobile marketplace system, where the billing preference indicating a billing party. The method further comprises authenticating a billing relationship between the network client and a mobile operator if the billing preference indicates the mobile operator as the billing party, and authenticating a billing relationship between the network client and the mobile marketplace system if the billing preference indicates the mobile marketplace system as the billing party. The method further comprises providing the mobile content item from the mobile marketplace system to the network client if the billing relationship between the network client and the billing party is authenticated.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an embodiment of a mobile content delivery system.

FIG. 2 shows an embodiment of a method of facilitating mobile content delivery.

FIG. 3 shows an embodiment of a method of authenticating a billing relationship between a network client and a mobile marketplace system.

FIG. 4 shows an embodiment of a method of authenticating a billing relationship between a network client and a mobile operator.

FIG. 5 shows a flow diagram depicting an example implementation of the method of FIG. 2.

### DETAILED DESCRIPTION

Various embodiments are disclosed herein that relate to mobile content delivery on a mobile network. In particular, the present disclosure provides a robust marketplace that supports very flexible content delivery. Whereas other marketplaces may sacrifice compatibility, choice, and flexibility for simplicity, the herein described marketplace provides unhindered choice, compatibility, and flexibility while presenting end users with at least the same level of simplicity found in less robust marketplaces. In this way, a user may seamlessly purchase content for a mobile device using any suitable payment or billing process, thereby potentially reducing the transaction to a simple acknowledgement by the user of his or her intent to purchase the content. As described in more detail below, the herein described marketplace accommodates a virtually endless number of different mobile operators, a virtually endless number of different billing conventions (e.g., mobile operator billing, credit card billing, electronic bank billing, etc.), a virtually endless number of different user identification protocols, as well as other levels of flexibility.

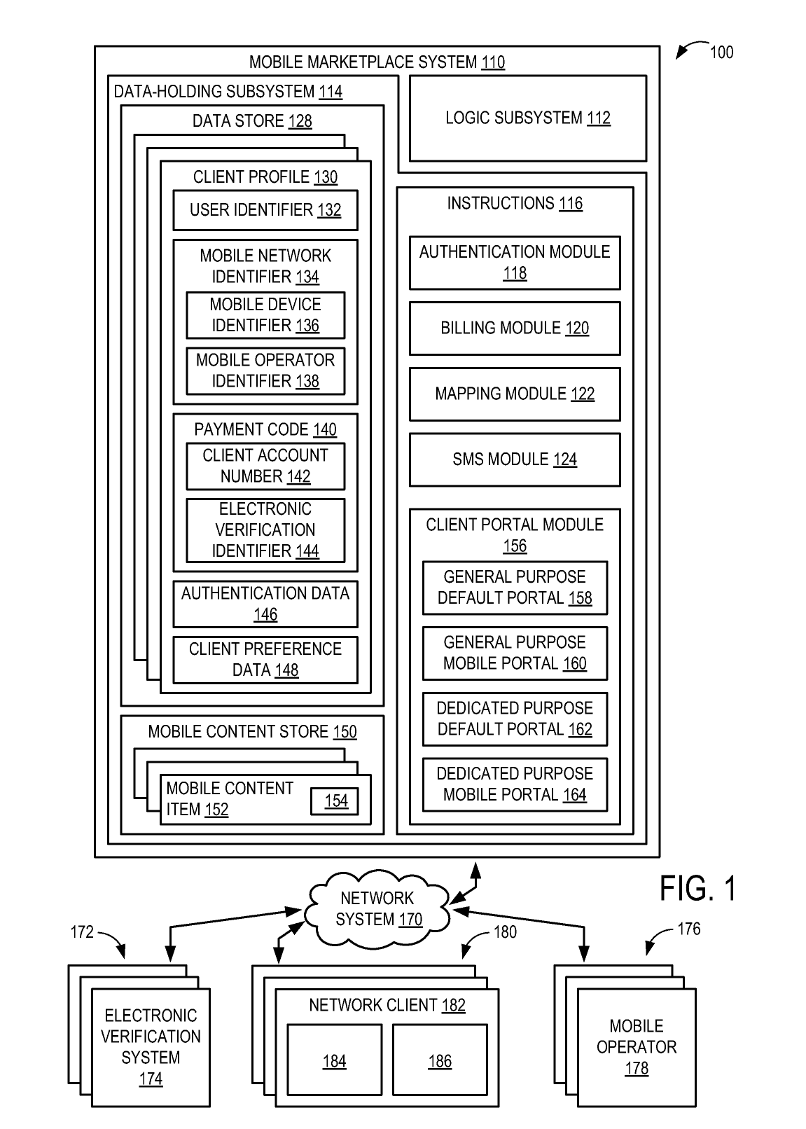

FIG. 1 shows an example embodiment of a mobile content delivery system 100. Mobile content delivery system 100 may include a mobile marketplace system 110, which provides a platform enabling network clients to purchase mobile content for mobile devices. Mobile marketplace system 110 will be described in the context of a single computing device, yet it should be appreciated that mobile marketplace system 110 may comprise two or more computing devices acting in coordination with each other.

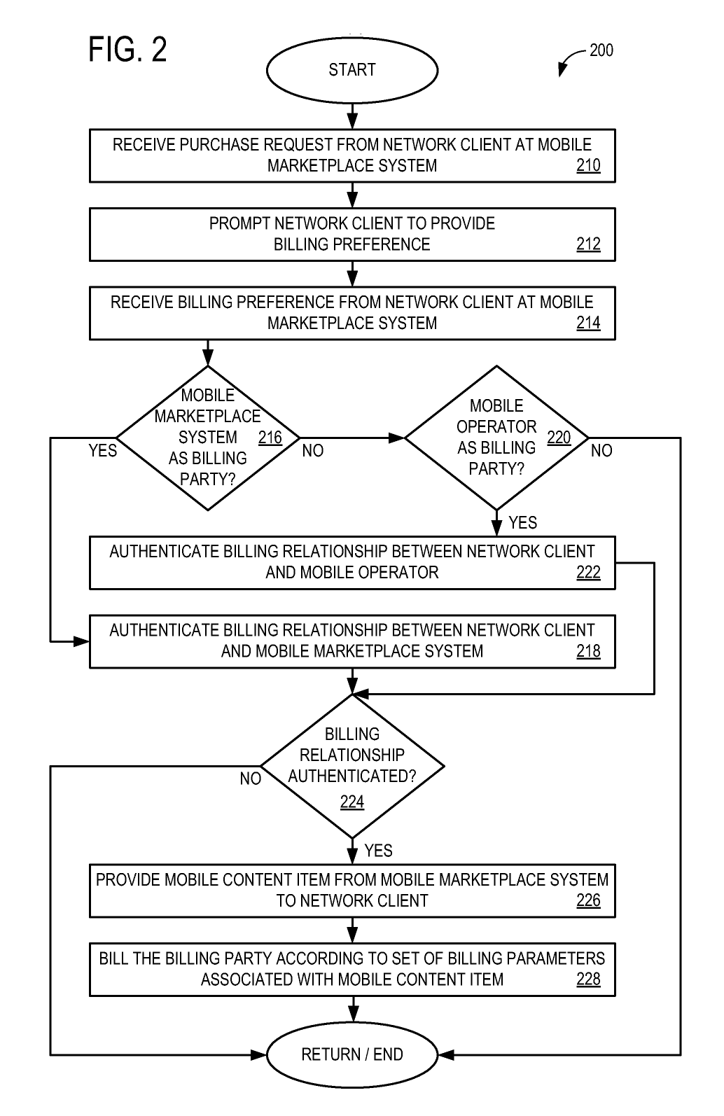

Mobile marketplace system 110 may include a logic subsystem 112 and a data-holding subsystem 114. Logic subsystem 112 may comprise one or more processors. Data-holding subsystem 114 is shown holding instructions 116 executable by logic subsystem 112, which may be used to implement one or more of the herein disclosed methods. Instructions 116 may comprise one or more modules (e.g., software modules), including one or more of an authentication module 118, a billing module 120, a mapping module 122, and a short message service (SMS) module 124. These modules will be described in greater detail with reference to methods 200, 300, and 400 of FIGS. 2-4.

Data-holding subsystem 114 may include a client profile store 128 configured to store one or more client profiles, a non-limiting example of which will be described in greater detail with reference to client profile 130. Client profile 130 may include one or more of a user identifier 132, a mobile network identifier 134, a payment code 140, authentication data 146, and client preference data 148.

Mobile network identifier 134 may include one or more of a mobile device identifier 136 and a mobile operator identifier 138. As one example, the mobile network identifier is an electronic serial number of a mobile device (e.g., first computing device 184) of a network client (e.g., network client 182) that may be captured by the mobile marketplace system. As another example, mobile network identifier 134 may include one or more of an international mobile subscriber identity (IMSI), a mobile subscriber integrated services digital network number (MSISDN), and a mobile operator alias which may be captured by the mobile marketplace system. For example, the mobile operator alias may be captured by the mobile marketplace system through a mobile operator wireless access protocol gateway. In some embodiments, the mobile operator alias is a one-way hashed version of MSISDN or IMSI. Mobile device identifier 136 may be used by mobile marketplace system 110 to indicate a network client (e.g., network client 182) of a plurality of network clients 180 and a mobile operator (e.g., mobile operator 178) of a plurality mobile operators 176.

Payment code 140 may include one or more of a client account number 142 and an electronic verification identifier 144. In some embodiments, payment code 140 is an ISO 7812 number, such as a credit card number, a debit card number, or other suitable identifier for facilitating an electronic financial transaction.

Data-holding subsystem 114 may include a mobile content store 150 including one or more mobile content items, a non-limiting example of which will be described in greater detail with reference to mobile content item 152. As one example, mobile content item 152 may include a mobile application such as a software application for the mobile device.

As another example, mobile content item 152 may include media content such as an audio file or a video file. In some embodiments, mobile content item 152 may further include associated meta data 154. Meta data 154 may comprise a set of billing parameters associated with the mobile content item. A billing parameter may include one or more of a price to be paid for the mobile content item, a currency associated with the price, a language associated with the mobile content item, and a billing definition defining when a billing party is to be billed for the mobile content item that is purchased by the network client relative to when the mobile content item is delivered to the network client. In some embodiments, the meta data may include targeted content that is based on the geographical location of the network client. For example, the network client for a United States based user may be provided different content in comparison with other geographical locations.

In some embodiments, mobile content store may be located remotely from the mobile marketplace system (e.g., at a web server or other suitable storage system), where it may be accessible via network system 170. It should be appreciated that data-holding subsystem 114 may hold instructions that are executable by the logic subsystem to provide mobile content store 150, which is configured to store a plurality of mobile content items, including mobile content item 152.

Data-holding subsystem 114 may include a client portal module 156. Client portal module 156 may include one or more portals (e.g., access points) for enabling network clients to access mobile marketplace system 110. For example, client portal module 156 may include one or more of a general purpose default portal 158, a general purpose mobile portal 160, a dedicated purpose default portal 162, and a dedicated purpose mobile portal 164, each of which may provide a graphical user interface that enables a network client to interact with the mobile marketplace system.

As one example, general purpose default portal 158 may include a website (e.g., a collection of one or more webpages) that may be accessed by a network client (e.g., network client 182) via a general purpose web browser. In some embodiments, client portal module 156 may provide general purpose default portal 158 as a default access point for network clients to access mobile marketplace system 1 10. By contrast, general purpose mobile portal 160 may include a website that may be accessed by a mobile device (e.g., a computing device possessing mobile capability) via a general purpose mobile web browser. General purpose mobile portal 160 may be adapted to or configured specifically for mobile devices in contrast to general purpose default portal 158 which may be adapted to or configured for a broader range of computing devices, including both stationary devices and mobile devices.

As another example, dedicated purpose default portal 162 may provide an access point for a network client (e.g., network client 182) via a dedicated purpose software application that resides locally at the network client. By contrast, dedicated purpose mobile portal 164 may provide an access point for a network client via a dedicated purpose software application that is specifically adapted to or configured for mobile devices. Hence, dedicated purpose default portal 162 may be adapted to or configured for a wider range of computing devices than dedicated purpose mobile portal 164, including both stationary devices and mobile devices.

Mobile content delivery system 100 may further include a plurality of network clients 180, including network client 182. Network client 182 may include or may be associated with one or more computing devices, such as a first computing device 184 and a second computing device 186. As one example, first computing device 184 is a mobile device and second computing device 186 is a stationary device. As another example, first computing device 184 is a mobile device having limited hardware capabilities relative to second computing device 186 which is a mobile device or a stationary device. As will be described in greater detail with reference to method 200 of FIG. 2, mobile content may be purchased by network client 182 via second computing device 186 for use with first computing device 184.

Mobile content delivery system 100 may further include a plurality of mobile operators 176, including mobile operator 178. In some embodiments, the plurality of mobile operators 176 include mobile device service providers that provide telephone service and/or data service to at first computing device 184 (e.g., where first computing device 184 includes a mobile device).

Mobile content delivery system 100 may further include a plurality of electronic verification systems 172, including electronic verification system 174. In some embodiments, the plurality of electronic verification systems 172 may include credit card issuers, banking agents, or other suitable financial institutions.

Each of mobile marketplace system 110, the plurality of network clients 180, the plurality of electronic verification systems 172, and the plurality of mobile operators 176 may communicate with each other via a network system 170. Network system 170 may include one or more data networks, including local area networks (LAN) and wide area networks (WAN) (e.g., the Internet). In some embodiments, network system 170 may include a plurality of different networks. For example, network system 170 may include the Internet and one or more mobile communication networks. For example, mobile operator 178 may facilitate mobile communication for a mobile device (e.g., first computing device 184) of network client 182 via a mobile communication network of network system 170, while an Internet service provider (not shown in FIG. 1) may facilitate Internet access for computing device 186 of network client 182. Hence, network client 182 may access mobile marketplace system 110 via one or more of the Internet and a mobile communication network facilitated by mobile operator 178. Other network clients of the plurality of network clients 180 may also communicate with mobile marketplace system 110 via their respective mobile operator of the plurality of mobile operators 176.

FIG. 2 shows an embodiment of a method 200 of facilitating mobile content delivery. As one example, method 200 may be performed by mobile marketplace system 110 on a mobile network of network system 170. Method 200 provides at least two ways in which a network client may purchase mobile content from mobile marketplace system.

At 210, the method includes receiving a purchase request from a network client (e.g., network client 182 of FIG. 1) at a mobile marketplace system (e.g., mobile marketplace system 110). In some embodiments, the purchase request indicates a mobile content item (e.g., mobile content item 152) to be purchased by the network client. For example, client portal module 156 of FIG. 1 can provide a user interface by which the network client can browse and purchase a mobile content item from a plurality of mobile content items. In some embodiments, the mobile marketplace system may be configured to receive a purchase request from a network client via a client portal module (e.g., client portal module 156 of FIG. 1).

At 212, the method includes prompting the network client to provide a billing preference that indicates a billing party. In some embodiments, the process of prompting the network client may include transmitting billing preference request from the mobile marketplace system to the network client. As one example, the network client may be prompted to select a billing preference indicating a particular billing party from two or more billing preferences. In some embodiments, a billing module (e.g., billing module 120) of the mobile marketplace system may be configured to prompt the network client to provide the billing preference.

In some embodiments, the process at 212 may include capturing an electronic serial number (e.g., some or all of mobile network identifier 134 of FIG. 1) of the mobile device at the mobile marketplace system and setting the billing preference at the mobile marketplace system based on the electronic serial number of the mobile device. As one example, the mobile marketplace system may verify one or more capabilities of the mobile device and its operating system indicated by the electronic serial number, and may set the billing preference according to the one or more of the hardware or software capabilities of the mobile device. As another example, the mobile marketplace system may identify a policy or rule set by the mobile operator of the mobile device indicated by the electronic serial number, and may set the billing preference according to the policy or rule set by the mobile operator. As yet another example, the mobile marketplace system may identify a previous subscription status or purchase history of the network client indicated by the electronic serial number, and may set the billing preference according to the previous subscription status or purchase history of the network client (e.g., to prevent fraud or double billing). For example, the mobile marketplace system may deny authorization of the network client based on the previous subscription status or purchase history of the network client. In some embodiments, the previous subscription status or purchase history of the network client may be stored at a client profile (e.g., client profile 130) of the network client where it may be later referenced for setting the billing preference.

At 214, the method includes receiving the billing preference from the network client at the mobile marketplace system. In some embodiments, the billing preference indicates a billing party that was selected by the network client. As one example, the billing preference may indicate a mobile operator (e.g., mobile operator 178 of FIG. 1) of a plurality of mobile operators (e.g., the plurality of mobile operators 176 of FIG. 1) as the billing party. As another example, the billing preference may indicate the mobile marketplace system as the billing party. In some embodiments, the billing preference may be received from the network client at a billing module (e.g., billing module 120 of FIG. 1). In some embodiments, process 214 may be omitted, for example, where the mobile marketplace system sets the billing preference of the network client based on an electronic serial number of a mobile device of the network client.

At 216, it may be judged whether the billing preference indicates the mobile marketplace system as the billing party. If the answer at 216 is judged yes, then the process flow may proceed to 218. At 218, the method includes authenticating a billing relationship between the network client and the mobile marketplace system if the billing preference indicates the mobile marketplace system as the billing party. In some embodiments, an authentication module (e.g., authentication module 118 of FIG. 1) may be configured to authenticate the billing relationship between the network client and the mobile marketplace system. For example, in response to the billing preference indicating the mobile marketplace system as the billing party, the authentication module may perform process 218.

Alternatively, if the answer at 216 is judged no, then the process flow may instead proceed to 220. At 220, it may be judged whether the billing preference indicates the mobile operator as the billing party. If the answer at 220 is judged yes, then the process flow may proceed to 222. At 222, the method includes authenticating a billing relationship between the network client and the mobile operator if the billing preference indicates the mobile operator as the billing party. In some embodiments, an authentication module (e.g., authentication module 118 of FIG. 1) may be configured to authentication the billing relationship between the network client and the mobile operator. For example, in response to the billing preference indicating the mobile operator as the billing party, the authentication module may perform process 222. Alternatively, if the answer at 220 is judged no, the process flow may instead test for a different billing party (not shown), return, or end.

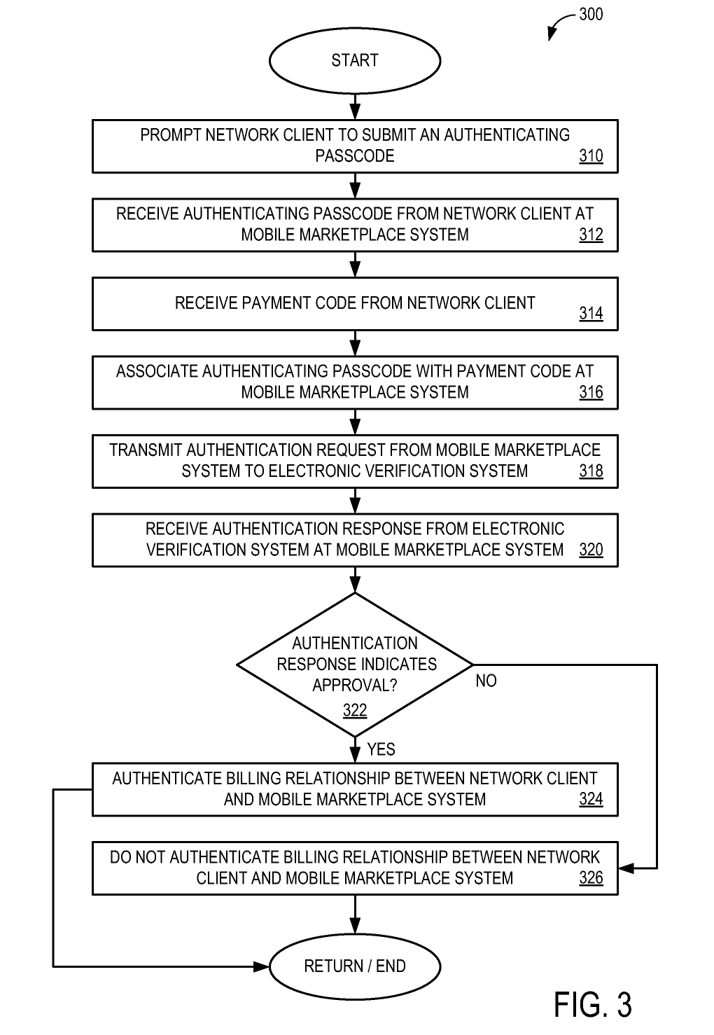

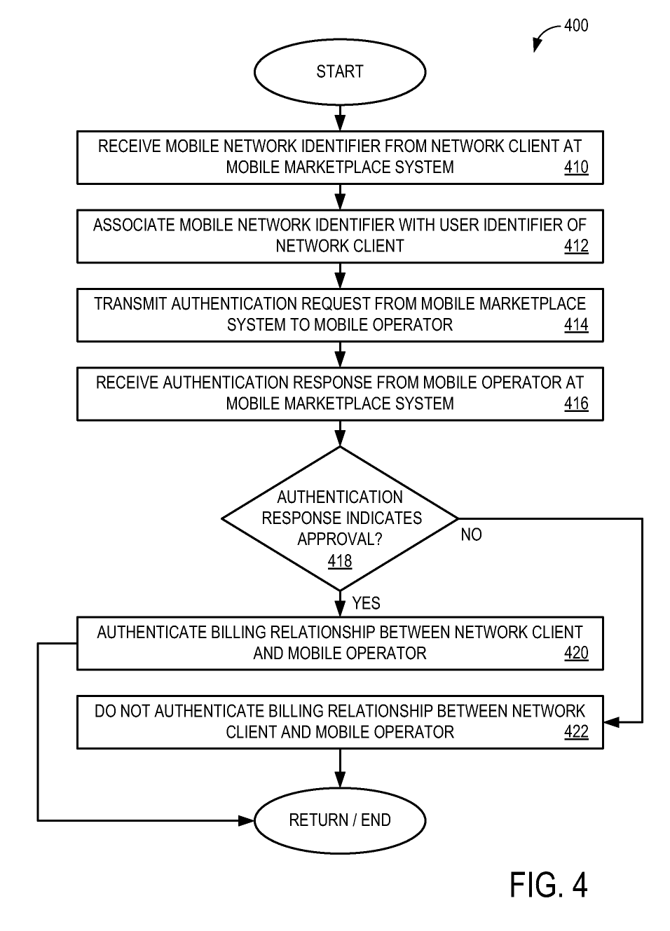

From either process 218 or process 222, the process flow may proceed to 224 where it may be judged whether the billing relationship has been authenticated. Method 300 of FIG. 3 and method 400 of FIG. 4 provide examples for identifying whether the billing relationship is authenticated. If the answer at 224 is judged yes, the process flow may proceed to 226. Alternatively, if the answer at 224 is judged no, the process flow may return or end.

At 226, the method may include providing the mobile content item from the mobile marketplace system to the network client if the billing relationship between the network client and the billing party is authenticated. In some embodiments, the process of providing the mobile content item from the mobile marketplace system to the network client may include retrieving the mobile content item from the mobile content store and transmitting the mobile content item to the network client. Where the network client includes a mobile device the process of providing the mobile content item to the network client includes transmitting the mobile content item to the mobile device.

In some embodiments, such as where the mobile content store is located remotely from the mobile marketplace system, the process of providing the mobile content item from the mobile marketplace system to the network client may include transmitting a followable reference (e.g., a hyperlink, a universal resource locator (URL), or other suitable reference) from the mobile marketplace system to the network client. The followable reference may be used by the network client to retrieve or to access the mobile content item.

At 228, the method may include billing the billing party according to a set of billing parameters associated with the mobile content item indicated by the purchase request. In some embodiments, the set of billing parameters associated with the mobile content item may comprise associated meta data (e.g., associated meta data 154 of FIG. 1) of the mobile content item. In some embodiments, a bill may be transmitted from a billing module (e.g., billing module 120 of FIG. 1) of the mobile marketplace system to the billing party on behalf of the network client according to the set of billing parameters.

As one example, the set of billing parameters indicates one or more of a price to be paid for the mobile content item and a billing definition that defines when the billing party is to be billed for the mobile content item relative to when the mobile content item is provided to the network client, and a frequency at which the network client is to be billed. In some embodiments, the billing definition may define whether the mobile marketplace system is to bill the network client via the billing party before providing the mobile content item to the network client or whether the mobile marketplace system is to bill the network client via the billing party at some time after providing the mobile content item to the network client (e.g., after a defined trial period has expired). In some embodiments, the billing definition may define whether the network client is to be billed one time for a mobile content item or whether the network client is to be billed on a reoccurring basis (e.g., as a subscription). From process 228, the process flow may return or end.

FIG. 3 shows an embodiment of a method 300 of authenticating a billing relationship between a network client and a mobile marketplace system. As one example, method 300 may be performed by mobile marketplace system 110 of FIG. 1 consistent with process 218 of FIG. 2. Hence, the process of authenticating the billing relationship between the network client and the mobile marketplace system may further comprise one or more processes of method 300. In some embodiments, method 300 may be performed by the mobile marketplace system to carry out a credit card transaction or other suitable electronic financial transaction.

At 310, the method includes prompting the network client to submit an authenticating passcode. In some embodiments, the process of prompting the network client may include transmitting a passcode request from the mobile marketplace system to the network client. The passcode request may further prompt the network client to provide a user identifier that identifies the network client.

At 312, the method includes receiving the authenticating passcode from the network client at the mobile marketplace system. In some embodiments, the authenticating passcode may be accompanied by the user identifier, which may be used by the mobile marketplace system to determine whether the authenticating passcode that was received from the network client corresponds to an authenticating passcode that is associated with the user identifier at the mobile marketplace system. As one example, authentication data 146 of FIG. 1 may include the authenticating passcode that is associated with the user identifier 132 in the client profile 130. It should be appreciated that any suitable passcode authentication process may be used at 312. In some embodiments, the authenticating passcode may be received from the network client at an authentication module (e.g., authentication module 118).

At 314, the method may include receiving a payment code from the network client. In some embodiments, the payment code includes one or more of a client account number indicating the network client and an electronic verification identifier indicating an electronic verification system. As one example, the payment code is an ISO 7812 number such as a credit card number, a debit card number, or a bank card number. As another example, the payment code is one or more of a bank account number and a bank routing number. In some embodiments, a billing module (e.g., billing module 120 of FIG. 1) may be configured to receive the payment code from the network client.

At 316, the method may include associating the authenticating passcode with the payment code at the mobile marketplace system. As one example, mapping module 122 of FIG. 1 may be configured to associate payment code 140 of FIG. 1 with one or more of the user identifier 132 and authentication data 146 (including the authenticating passcode) by storing the payment code, the authenticating passcode, and the user identifier in the client profile. In some embodiments, the mobile marketplace system may provide a mapping module (e.g., mapping module 122) that is configured to associate the authenticating passcode with the payment code.

At 318, the method includes transmitting an authentication request from the mobile marketplace system to the electronic verification system indicated by the electronic verification identifier. In some embodiments, the authentication request includes the client account number of the payment code. As one example, authentication module 118 of FIG. 1 may be configured to format and transmit the authentication request to an electronic verification system (e.g., electronic verification system 174) of a plurality of electronic verification systems. In some embodiments, an authentication module (e.g., authentication module 118 of FIG. 1) may be configured to transmit the authentication request to the electronic verification system indicated by the electronic verification identifier.

At 320, the method includes receiving an authentication response from the electronic verification system. As one example, mobile marketplace system 110 of FIG. 1 may receive the authentication response from electronic verification system 174 in response to the authentication request. The authentication response may indicate an approval of the billing relationship between the network client and the mobile marketplace system or the authentication response may indicate a denial of the billing relationship between the network client and the mobile marketplace system depending on a status determination performed by the electronic verification system. In some embodiments, the authentication response may be received from the electronic verification system at the authentication module.

At 322 it may be judged whether the authentication response indicates an approval of the billing relationship. If the answer at 322 is judged yes, the process flow may proceed to 324. At 324, the method may include authenticating the billing relationship between the network client and the mobile marketplace system. At 326, authentication may not be performed for the billing relationship between the network client and the mobile marketplace system. For example, the authentication response may instead indicate a denial of the billing relationship. From process 324 or process 326, the process flow may return or end.

FIG. 4 shows an embodiment of a method 400 of authenticating a billing relationship between a network client and a mobile operator. As one example, method 400 may be performed by mobile marketplace system 110 of FIG. 1 consistent with process 222 of FIG. 2. Hence, the process of authenticating the billing relationship between the network client and the mobile operator may further comprise one or more processes of method 400. In some embodiments, method 400 may be performed by the mobile marketplace system to enable the network client to purchase mobile content from the mobile marketplace system using a pre-existing or pre-established billing relationship between the network client and a mobile operator of a mobile device of the network client.

At 410, the method includes receiving a mobile network identifier (e.g., mobile network identifier 134 of FIG. 1) from the network client at the mobile marketplace system. In some embodiments, the mobile network identifier includes a mobile device identifier (e.g., mobile device identifier 136 of FIG. 1) indicating the network client and a mobile operator identifier (e.g., mobile operator identifier 138 of FIG. 1) indicating the mobile operator. Hence, the mobile device identifier may be used by the mobile marketplace system to identify the network client from a plurality of network clients and the mobile operator identifier may be used by the mobile marketplace system to identify the mobile operator from a plurality of mobile operators.

At 412, the method includes associating the mobile network identifier with a user identifier. As one example, the mapping module 122 of FIG. 1 may be configured to store mobile network identifier 134 in client profile 130 with user identifier 132.

At 414, the method includes transmitting an authentication request from the mobile marketplace system to the mobile operator indicated by the mobile operator identifier. In some embodiments, the authentication request may include the mobile device identifier. As one example, SMS module 124 of FIG. 1 may be configured to format an SMS message (e.g., a premium SMS message) in accordance with a protocol of the mobile operator indicated by the mobile operator identifier and transmit the SMS message to the mobile operator.

At 416, the method may include receiving an authentication response from the mobile operator at the mobile marketplace system for the network client indicated by the mobile device identifier. For example, the authentication response may include an SMS message that may be received by SMS module 124. Hence, the process of transmitting the authentication request to the mobile operator may include transmitting a first short messaging service (SMS) message from the mobile marketplace system to the mobile operator, and the process of receiving the authentication response from the mobile operator may include receiving a second SMS message. For example, the SMS module (e.g., SMS module 124) may be configured to transmit a first short messaging service (SMS) message from the mobile marketplace system to the mobile operator that includes the authentication request in accordance with process 414 and receive the authentication response from the mobile operator in accordance with process 416 by receiving a second SMS message from the mobile operator at the SMS module. In some embodiments, the mobile marketplace system may be configured to receive the SMS response by intercepting the SMS response without enabling the network client to obtain or observe the SMS response.

At 418 it may be judged whether the authentication response indicates an approval of the billing relationship between the network client and the mobile operator. If the answer at 418 is judged yes, the process flow may proceed to 420. At 420, the method may include authenticating the billing relationship between the network client and the mobile operator. Alternatively, if the answer at 420 is judged no, the process flow may instead proceed to 422. At 422, authentication may not be performed for the billing relationship between the network client and the mobile operator. For example, the authentication response may instead indicate a denial of the billing relationship. From process 420 or process 422, the process flow may return or end.

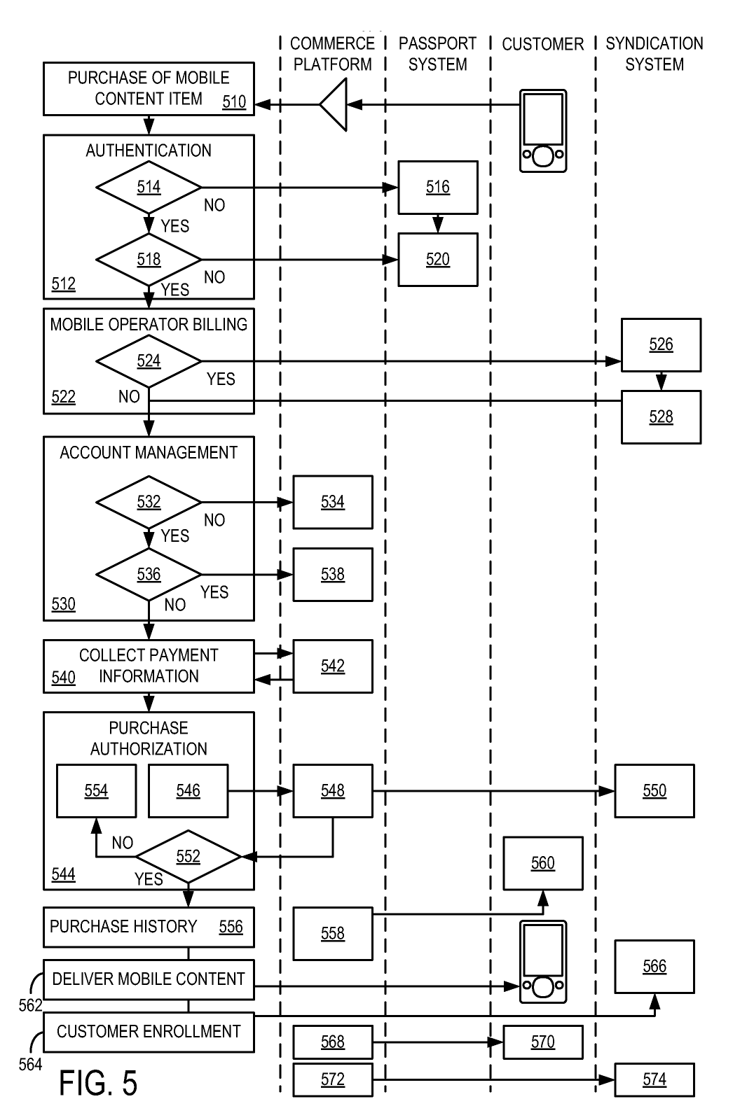

FIG. 5 shows a flow diagram depicting an example implementation of method 200 of FIG. 2 in the context of mobile content delivery system 100 of FIG. 1. At 510, a mobile content item may be purchased by a customer (e.g., network client 182 of FIG. 1) via mobile content store front. For example, as shown in FIG. 1 the customer may access mobile content store 150 via client portal module 156, which may expose a user interface of one or more of general purpose default portal 158 (e.g., a website), general purpose mobile portal 160 (e.g., a website adapted for a mobile device), dedicated purpose default portal 162 (e.g., a mobile marketplace application), and dedicated purpose mobile portal 164 (e.g., a mobile marketplace application adapted for a mobile device).

As shown in FIG. 5, the purchase of the mobile content item by the customer may be facilitated by an intermediate commerce platform in some examples. The commerce platform may maintain a history of the customer's transactions with the mobile marketplace system. Authentication of the customer may be performed at 512, where it may be judged at 514 whether the customer has a user identifier (e.g., user identifier 132 of FIG. 1). If the answer at 514 is judged no, the customer may be prompted to sign-up for a user identifier at 516 via a passport system. The customer may be prompted to provide a passcode that may be associated with the user identifier in the customer's profile (e.g., client profile 130 of FIG. 1).

At 520, the customer may use the client identifier and passcode to sign-in to the mobile marketplace system. In some examples, the passport system may facilitate authentication of the customer on behalf of the mobile marketplace system by prompting the customer for the client identifier and passcode before authenticating a billing relationship between the customer and a billing party. At 518, it may be judged whether the customer has signed-in. If the answer at 518 is judged yes, the process flow may proceed to mobile operator billing 522.

At mobile operator billing 522, it may be judged at 524 whether mobile operator billing is to be used for the purchase of the mobile content item. As previously described with reference to method 200 of FIG. 2, a network client may provide a billing preference that indicates whether the billing party is a mobile operator or the mobile marketplace system. If the answer at 524 is judged yes, the process flow may proceed to 526 where a syndication system may identify a billing protocol for the mobile operator. For example, the syndication system may provide a definition of how the authentication request is to be formatted by the mobile marketplace system before it is transmitted to the mobile operator. At 528, identification mapping may be performed to obtain the requisite billing information for the customer from the customer's profile in accordance with the billing identification determined at 526.

At 530, account management may be performed, where it may be judged at 532 whether the customer has provided a payment code (e.g., credit card number) to the mobile marketplace system. If the answer at 532 is no, the commerce platform may provide an account management service that enables the customer to submit a payment code, which may be associated with the customer's client identifier.

At 536, it may be judged whether one or more of the payment codes stored in the customer's profile are active. If there are no active payment codes in the customer's profile, then the customer may be directed to a billing and account management service 538 that enables the customer to provide an active payment code. It will be appreciated that payment codes may be stored in the customer's profile for only some payment processes (e.g., credit card payment), while a payment code may not be stored in the customer's profile for other payment processes, such as SMS billing. As another example, if there are multiple active payment codes in the customer's profile, then the customer may be directed to billing and account management service 538 to select a payment code of a plurality of payment codes stored in the customer's profile.

At 540, payment information may be collected, which may be provided to the customer at 542. As one example, the payment information may be presented to the customer at 542 as a transaction summary, and may provide a description of the mobile content item that is being purchased and a price of the mobile content item that is to be charged to the customer's payment code, among other suitable transaction information. The customer may change or amend the transaction at 542 in response to the transaction summary, or the customer may accept the transaction.

At 544, purchase authorization may be performed. For example, at 546, the commerce platform may be provided with transaction parameters such as an amount to be charged to the payment code of the client, the billing party, etc. The commerce platform may format the transaction parameters and forward the transaction parameters to the billing party as an authorization request (e.g., as described at process 318 of FIG. 3 and process 414 of FIG. 4). If the authentication request is approved, then the transaction parameters may be stored at 550 via the syndication system. If it is judged at 552 that authorization has not been approved, then an authorization denied message may be provided to the customer at 554. Alternatively, if the authorization is approved, then the process flow may proceed to 556.

At 556, a purchase history may be recorded (e.g., in client profile 130) for the transaction, and a billing notification 558 may be transmitted to the customer as indicated at 560. At 562, the mobile content item may be delivered to the mobile device of the customer. At 564, customer enrollment may be performed if the mobile content item is a subscription based service (e.g., as indicated by a set of billing parameters associated with the mobile content item). A billing notification 568 may be provided to the customer as indicated at 570 for each time a subscription fee is charged to the customer's account. At 572, one or more of recurring billing, cancellation of billing, suspension of billing, or resumption of billing may be performed for the subscription service of the mobile content item. At 574, events associated with the recurring, cancellation, suspension, or resumption of billing may be recorded at 574 by the syndication system.

Logic subsystem 112 of FIG. 1 may include one or more physical devices configured to execute one or more instructions. For example, the logic subsystem may be configured to execute one or more instructions that are part of one or more programs, routines, objects, components, data structures, or other logical constructs. Such instructions may be implemented to perform a task, implement a data type, transform the state of one or more devices, or otherwise arrive at a desired result. The logic subsystem may include one or more processors that are configured to execute software instructions. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments.

Data-holding subsystem 114 of FIG. 1 may include one or more physical devices configured to hold data and/or instructions executable by the logic subsystem to implement the herein described methods and processes. When such methods and processes are implemented, the state of data-holding subsystem 114 may be transformed (e.g., to hold different data). Data-holding subsystem 114 may include removable media and/or built-in devices. Data-holding subsystem 114 may include optical memory devices, semiconductor memory devices, and/or magnetic memory devices, among others. Data-holding subsystem 114 may include devices with one or more of the following characteristics: volatile, nonvolatile, dynamic, static, read/write, read-only, random access, sequential access, location addressable, file addressable, and content addressable. In some embodiments, logic subsystem 112 and data-holding subsystem 114 may be integrated into one or more common devices, such as an application specific integrated circuit or a system on a chip.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

It will be appreciated that the computing devices described herein may be any suitable computing device configured to execute the programs described herein. For example, the computing devices may be a mainframe computer, personal computer, laptop computer, portable data assistant (PDA), computer-enabled wireless telephone, networked computing device, or other suitable computing device, and may be connected to each other via computer networks, such as the Internet. These computing devices typically include a processor and associated volatile and non-volatile memory, and are configured to execute programs stored in non-volatile memory using portions of volatile memory and the processor. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that computer-readable media may be provided having program instructions stored thereon, which upon execution by a computing device, cause the computing device to execute the methods described above and cause operation of the systems described above.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A method of facilitating mobile content delivery on a mobile network, the method comprising:
receiving a purchase request from a network client at a mobile marketplace system, the purchase request indicating a mobile content item to be purchased by the network client and the mobile marketplace system being configured to sell the mobile content item to the network client using a particular billing party from two or more participating billing parties;
prompting the network client to provide a billing preference indicating the particular billing party from the two or more participating billing parties;
receiving the billing preference from the network client at the mobile marketplace system;
authenticating a billing relationship between the network client and a mobile operator if the billing preference indicates the mobile operator as the particular billing party;
authenticating a billing relationship between the network client and the mobile marketplace system if the billing preference indicates the mobile marketplace system as the particular billing party; and
providing the mobile content item from the mobile marketplace system to the network client if the billing relationship between the network client and the particular billing party is authenticated.

2. The method of claim 1, where authenticating the billing relationship between the network client and the mobile operator comprises:
receiving a mobile network identifier from the network client at the mobile marketplace system, the mobile network identifier including a mobile device identifier indicating the network client and a mobile operator identifier indicating the mobile operator;
transmitting an authentication request from the mobile marketplace system to the mobile operator indicated by the mobile operator identifier, the authentication request including the mobile device identifier; and
receiving an authentication response from the mobile operator at the mobile marketplace system for the network client indicated by the mobile device identifier, the authentication response indicating an approval of the billing relationship between the network client and the mobile operator.

3. The method of claim 2, further comprising, associating the mobile network identifier with a user identifier of the network client at the mobile marketplace subsystem.

4. The method of claim 2, where the mobile network identifier is an electronic serial number associated with a mobile device of the network client.

5. The method of claim 2, where the mobile network identifier includes one or more of an international mobile subscriber identity (IMSI) and a mobile subscriber integrated services digital network number (MSISDN).

6. The method of claim 2, where transmitting the authentication request to the mobile operator includes transmitting a first short messaging service (SMS) message from the mobile marketplace system to the mobile operator; and
where receiving the authentication response from the mobile operator includes receiving a second SMS message.

7. The method of claim 1, where authenticating the billing relationship between the network client and the mobile marketplace system includes:
prompting the network client to submit an authenticating passcode;
receiving the authenticating passcode from the network client at the mobile marketplace system;
receiving a payment code from the network client, the payment code including a client account number indicating the network client and an electronic verification identifier indicating an electronic verification system;
associating the authenticating passcode with the payment code at the mobile marketplace system;
transmitting an authentication request from the mobile marketplace system to the electronic verification system indicated by the electronic verification identifier, the authentication request including the client account number; and
receiving an authentication response from the electronic verification system, the authentication response indicating an approval of the billing relationship between the network client and the mobile marketplace system.

8. The method of claim 7, where the payment code is an ISO 7812 number.

9. The method of claim 1, where the network client includes a mobile device; and where providing the mobile content item to the network client includes transmitting the mobile content item to the mobile device.

10. The method of claim 9, where the mobile content item comprises a software application for the mobile device.

11. The method of claim 1, further comprising billing the particular billing party according to a set of billing parameters associated with the mobile content item indicated by the purchase request;
where the set of billing parameters indicates one or more of a price to be paid for the mobile content item and a billing definition defining when the particular billing party is to be billed for the mobile content item relative to when the mobile content item is provided to the network client.

12. A mobile marketplace system for a mobile network, comprising:
a logic subsystem including a processor;
a data-holding subsystem configured to hold instructions executable by the logic subsystem to:
provide a mobile content store configured to store a plurality of mobile content items;
receive a purchase request from a network client via a client portal module, the purchase request indicating a mobile content item to be purchased by the network client of the plurality of mobile content items, the mobile content store configured to sell the mobile content item to the network client using a particular billing party from two or more participating billing parties;
provide a billing module configured to prompt the network client to provide a billing preference;
receive the billing preference from the network client at the billing module, the billing preference indicating the particular billing party;
provide an authentication module configured to:
authenticate a billing relationship between the network client and a mobile operator of a plurality of mobile operators if the billing preference indicates the mobile operator as the particular billing party;
authenticate billing relationship between the network client and the mobile marketplace system if the billing preference indicates the mobile marketplace system as the particular billing party; and
provide the mobile content item to the network client if the billing relationship between the network client and the particular billing party is authenticated by the authentication module.

13. The mobile marketplace system of claim 12, where the network client includes a mobile device and where the mobile content item comprises a software application for the mobile device.

14. The mobile marketplace system of claim 12, where the data-holding subsystem is further configured to hold instructions executable by the logic subsystem that, in response to the billing preference indicating the mobile operator as the particular billing party, is configured to:
receive a mobile network identifier from the network client, the mobile network identifier including a mobile device identifier indicating the network client and a mobile operator identifier indicating the mobile operator of the plurality of mobile operators;
transmit an authentication request to the mobile operator indicated by the mobile operator identifier, the authentication request including the mobile device identifier;
receive an authentication response from the mobile operator for the network client indicated by the mobile device identifier, the authentication response indicating an approval of the billing relationship between the network client and the mobile operator; and
where the authentication module is further configured to authenticate the billing relationship between the network client and the mobile operator if the authentication response indicates the approval of the billing relationship.

15. The mobile marketplace system of claim 12, where the data-holding subsystem is further configured to hold instructions executable by the logic subsystem to:
transmit the authentication request to the mobile operator by providing an SMS module that is configured to transmit a first short messaging service (SMS) message from the mobile marketplace system to the mobile operator that includes the authentication request; and
receive the authentication response from the mobile operator by receiving a second SMS message from the mobile operator at the SMS module.

16. The mobile marketplace system of claim 12, where the data- holding subsystem is further configured to hold instructions executable by the logic subsystem that, in response to the billing preference indicating the mobile marketplace system as the particular billing party, is configured to:
prompt the network client to submit an authenticating passcode;
receive the authenticating passcode from the network client at the authentication module;
provide a billing module that is configured to receive a payment code from the network client, the payment code including a client account number indicating the network client and an electronic verification identifier indicating an electronic verification system of a plurality of electronic verification systems;
provide a mapping module configured to associate the authenticating passcode with the payment code;
transmit an authentication request from the authentication module to the electronic verification system indicated by the electronic verification identifier, the authentication request including the client account number; and
receiving an authentication response from the electronic verification system at the authentication module, the authentication response indicating an approval of the billing relationship between the network client and the mobile marketplace system.

17. The mobile marketplace system of claim 16, where the data- holding subsystem is further configured to hold instructions executable by the logic subsystem to:
transmit a bill from the billing module to the particular billing party according to a set of billing parameters associated with the mobile content item indicated by the purchase request;
where the set of billing parameters indicates one or more of a price to be paid for the mobile content item and a billing definition defining when the particular billing party is to be billed by the billing module for the mobile content item relative to when the mobile content item is provided to the network client.

18. The mobile marketplace system of claim 12, where the mobile network identifier is an electronic serial number associated with a mobile device of the network client.

19. The mobile marketplace system of claim 12, where the mobile network identifier includes one or more of an international mobile subscriber identity (IMSI) and a mobile subscriber integrated services digital network number (MSISDN).

20. A method of facilitating mobile content delivery on a mobile network, the method comprising:
receiving a purchase request from a mobile device of a network client at a mobile marketplace system, the purchase request indicating a mobile content item to be purchased by the network client and the mobile marketplace system being configured to sell the mobile content item to the network client using a particular billing party from two or more participating billing parties;
capturing an electronic serial number of the mobile device at the mobile marketplace system;
setting a billing preference at the mobile marketplace system based on the electronic serial number of the mobile device, the billing preference indicating a particular billing party from two or more participating billing parties;
authenticating a billing relationship between the network client and a mobile operator of the mobile device if the billing preference indicates the mobile operator as the particular billing party;
authenticating a billing relationship between the network client and the mobile marketplace system if the billing preference indicates the mobile marketplace system as the particular billing party; and
providing the mobile content item from the mobile marketplace system to the mobile device if the billing relationship between the network client and the particular billing party is authenticated.
